(19) United States
(12) Patent Application Publication
(10) Pub. No.: US 2004/0112996 A1
(43) Pub. Date: Jun. 17, 2004

(54) Process for pulverization of polyurethane-containing materials

(75) Inventors: Robert Donald Villwock, Grass Valley, CA (US); Bryan Louis Martel, Nevada City, CA (US)

Correspondence Address: Kristin C. Castle, Castle & Gross LLP, Suite 100, 11231 Gold Express Drive, Gold River, CA, 95670, US

(73) Assignee: Mobius Technologies, Incorporated

(21) Appl. No.: 10/649,593

(22) Filed: Aug. 27, 2003

Related U.S. Application Data
(60) Provisional application No. 60/408,178, filed on Sep. 3, 2002.

(51) Int. Cl. B02C 19/12

(52) U.S. Cl. 241/22; 241/29

(57) ABSTRACT

The present invention comprises a method of comminuting/pulverizing polyurethane-containing materials to produce fine particles. The method of comminuting/pulverizing polyurethane-containing materials comprises first chopping the polyurethane-containing materials, thereby producing a polyurethane-containing flock. The polyurethane-containing flock is then processed to form a powder through a comminuting/pulverizing process wherein the comminuting/pulverizing process has at least two steps. Finally, a solid additive is added at any time during the comminuting/pulverizing process to prevent adherence of the polyurethane-containing materials powder during one of the at least two steps.

### CROSS REFERENCE TO RELATED APPLICATIONS

This application claims the benefit of U. S. Provisional Application No. 60/408,178 filed on Sep. 3, 2002.

### BACKGROUND

1. Field of the Invention

The present invention relates to processes for pulverization of polyurethane-containing materials. More specifically, the present invention relates to an improved process for the pulverization of polyurethane-containing materials comprising the addition of solid additives.

2. Background of the Invention

“Polyurethane” (PUR) describes a general class of polymers prepared by polyaddition polymerization of polyisocyanate molecules and one or more active-hydrogen compounds. “Active-hydrogen compounds” include water and polyfunctional hydroxyl-containing (or “polyhydroxyl”) compounds such as diols, polyester polyols, and polyether polyols. Active-hydrogen compounds also include polyfunctional amino-group-containing compounds such as polyamines and diamines. A common example of an active-hydrogen compound is a polyether polyol such as a glycerin-initiated polymer of ethylene oxide or propylene oxide. Polyether polyols that are useful for slabstock flexible polyurethane foams generally have a molecular weight in the range of 2000 to 6000 g/mol, a functionality in the range of 2 to 7 (preferably about 3), and a viscosity at 25° C. generally in the range of 100 to 10,000 mPa-s.

Polyurethane foams are formed via a reaction between one or more active-hydrogen compounds and a polyfunctional isocyanate component, resulting in urethane linkages. Polyurethane foams are widely used in a variety of products and applications. These foams may be formed in a wide range of densities and may be characterized as flexible, semi-flexible, semi-rigid, or rigid. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. “Semi-rigid” or “semi-flexible” foams are those that can be deformed, but may recover their original shape slowly, perhaps incompletely. A foam structure is formed by use of so-called “blowing agents.” Blowing agents are introduced during foam formation through the volatilization of low-boiling liquids or through the formation of gas due to chemical reaction. For example, a reaction between water and isocyanate forms carbon dioxide (CO₂) gas bubbles in polyurethane foam. This reaction also generates heat and results in urea linkages in the polymer. Additionally, surfactants may be used to stabilize the polymer foam structure during polymerization. Catalysts are used to initiate the polymerization reactions forming the urethane linkages and to control the blowing reaction for forming gas. The balance of these two reactions, which is controlled by the types and amounts of catalysts, is also a function of the reaction temperature. A typical foam recipe includes at least one polyol, at least one isocyanate, and also typically includes water, surfactant, and catalysts, and also optionally includes additional blowing agent, fillers, and additives for color, fire performance, antimicrobial activity, etc.

“Viscoelastic foam”, or “visco foam”, or “memory foam” refers to a type of flexible polyurethane foam that is easily deformable and has a slow recovery time. Foams of this type are used for special mattresses that provide a very even pressure distribution. They often consist of polymeric material that has a glass-transition temperature (T_{g}) slightly below room temperature. A typical example of viscoelastic foam is slow-recovery foam manufactured and used by Tempur Production of Lexington, Ky. in the United States or Danfoam in Denmark.

“Polyurethane-containing materials” includes, but is not limited to, polyurethane foams, shoe soles, molded polyurethanes such as reaction-injection molded polyurethanes and thermoplastic polyurethanes, and carpets. Some carpets have polyurethane backing layers and others do not, but we mean to include the various types of carpets in our general definition of polyurethane-containing materials in the sense that these carpets can be ground into fine particles and that the process can be improved by the addition of solid additives according to the invention.

Polyurethane-containing materials can be ground (or “pulverized” or “comminuted”) into fine particles using, for example, cryogenic processes or roll mills. The implementation of a method of grinding polyurethane foam is shown in U.S. patent application Ser. No. 09/748,307 filed on Dec. 21, 2000, by inventors Bryan Louis Martel, Robert Donald Villwock and Herman Stone, assigned to Mobius Technologies, Inc., entitled “POLYMERIC FOAM POWDER PROCESSING TECHNIQUES, FOAM POWDERS PRODUCTS, AND FOAMS PRODUCED CONTAINING THOSE FOAM POWDERS,” and hereby incorporated herein by reference.

These fine particles can then be used in various ways, for example to replace some of the chemicals in the manufacture of new polyurethanes. The use of the fine polyurethane particles as a replacement for chemicals in the manufacture of new foam can provide an environmental benefit and a cost savings. Finer particles are preferable for use as a replacement for chemicals in new foam for several reasons, including, but not limited to, lower viscosity of powder/polyol slurries, improved foam properties such as hardness, and improved processing and mixing. Fine particles obtained from grinding of various types of polyurethane-containing materials, not just from polyurethane foam, are useful to replace chemicals in the manufacture of new polyurethane-containing materials, including polyurethane foam.

In the process shown in U.S. patent application Ser. No. 09/748,307, foam and ground foam may be moved through the process of comminuting polymeric foam for example by means of pneumatic conveying. Fine particles, which have the desired maximum particle size, are separated from coarser particles, preferably by means of a sifter. It is desirable to maximize the rate at which the process can produce fine powder, to reduce the tendency of powder to coat the inside surfaces of the pneumatic conveying system, to reduce the tendency of the powder to stick to the openings of the sifter screen (“blinding”), to improve the ability of the sifter to select particles that have a size near the size of the screen openings, and to do all of the above while allowing the use of finer screens in the sifter. It is also desirable to reduce the amount of static electrical charge on the powder and foam within the process.

Hence what is needed is a process for the pulverization of polyurethane-containing materials that greatly improves the performance of the process by increasing rate of powder production by eliminating or greatly reducing plating of powder on the inside surfaces of a pneumatic conveying system, such as in ducts or cyclones. There is also a need for a process for the pulverization of polyurethane-containing materials that eliminates or greatly reduces blinding of the sifter screens and can produce powder with a maximum particle size that more nearly matches the size of the screen openings in a sifter. In addition, there is a need for a process for the pulverization of polyurethane-containing materials that allows the use of finer screens in the sifter. Also there is a need for a process for the pulverization of polyurethane-containing materials wherein static electrical charge on particles is minimized. Finally, there is a need for a process for the pulverization of polyurethane-containing materials that allows the efficient grinding of difficult materials, for example 100% viscoelastic foam.

### SUMMARY OF THE INVENTION

The present invention comprises a method of comminuting/pulverizing polyurethane-containing materials to produce fine particles. The method of comminuting/pulverizing polyurethane-containing materials comprises first chopping the polyurethane-containing materials, thereby producing a flock. The flock is then processed to form a powder through a comminuting/pulverizing process wherein the comminuting/pulverizing process has at least two steps. Finally, a solid additive is added at any time during the comminuting/pulverizing process to prevent adherence of the foam powder during one of the at least two steps.

A better understanding of the features and advantages of the present invention will be obtained by reference to the following detailed description of the invention and accompanying examples which set forth an illustrative embodiment in which the principles of the invention are utilized.

### BRIEF DESCRIPTION OF THE DRAWINGS

FIG. 1 is a simplified schematic diagram illustrating an example of a comminution/pulverization process of the present invention.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons.

The present invention comprises a process for the pulverization of polyurethane-containing materials that includes the addition of small amounts of solid additives. The addition of small amounts of solid additives greatly improves the performance of the process by increasing rate of powder production by eliminating or greatly reducing plating of powder on the inside surfaces of a pneumatic conveying system, such as in ducts, fans, or cyclones. The addition of small amounts of a solid additive also eliminates or greatly reduces blinding of the sifter screens and can produce powder with a maximum particle size that more nearly matches the size of the screen openings in a sifter. In addition, the addition of small amounts of solid particles allows the use of finer screens in the sifter. Also, the addition of small amounts of a solid additive reduces the amount of static electrical charge on the particles conveyed through the process. Also, the addition of small amounts of a solid additive improves the flowability of the powder product. Finally, the addition of small amounts of solid additives to polyurethane foam allows the efficient grinding of difficult foams, for example 100% viscoelastic foam.

In the present invention, “polyurethane-containing materials” includes, but is not limited to, polyurethane foams, shoe soles, molded polyurethanes such as reaction-injection molded polyurethanes and thermoplastic polyurethanes, and carpets. Some carpets have polyurethane backing layers and others do not.

It has been found that the addition of small amounts of solid additives allows for not only superior grinding of polyurethane-containing materials, but also superior separation of the fine powder from coarser material to be recycled back to the grinding operation.

The solid additives may be added to the comminution/pulverization process at the same feed location as the polyurethane-containing materials or added anywhere in the recirculation loop that returns oversized material to the mill for continued grinding, for example before the mill or after the mill. To have an effect on the grinding action in the mill, it is advantageous to add the solid additives prior to the mill, for example with the feed or in the coarse-material return line of the recirculation loop. In addition, the solid additives may be added to improve powder flowability. The solid additives may be added in the form of powders, or added upstream of the roll mill as larger particles which are subsequently reduced to powders by the process, or added to the feed material as part of a master batch. Typically, it has been found that only one application of the solid additive is necessary to accomplish the elimination or reduction of plating of powder on the inside surfaces of a pneumatic conveying system such as in ducts or cyclones.

It is further contemplated that, once the solid additives exit the grinding process with the desired finely ground powder product, the solid additives may be separated from the desired finely ground powder product by a further step. Such a subsequent step could be a physical or a chemical separation.

The solid additives may be electrically conductive or electrically insulating. Although this invention is not bound by any theory, solid additives may provide the benefits of the invention by means of their effect of reduction of static electrical charge on particles conveyed through the process. Electrically conductive solid additives may function by transferring charge from particles to the grounded metal surfaces of the process equipment. Electrically insulating solid additives may function by taking a triboelectric charge of opposite sign of the charge taken by the polyurethane-containing materials and thereby neutralizing the mixture. Electrically conductive or insulating solid additives may function by coating the surfaces of polyurethane-containing materials and thereby inhibiting tribocharging. The reduction of static electrical charge would then provide the benefits of the invention by reducing adherence of the particles to each other, to the conveying system, and/or to the other process equipment including the grinder and separator, such as sifter screens.

Specific examples of electrically conductive solid additives that provide the process improvements of the present invention include, but are no limited to, carbon black (e.g., CABOT VULCAN XC72R), graphite, flaked or powdered metals (e.g., iron, nickel, copper), conductive metal oxides such as tin oxide, conductive polymers such as polypyrrole, and electrically insulating materials coated with tin oxide (e.g., Milliken EC3010-XT tin-oxide-coated titanium dioxide powder).

Specific examples of electrically insulating solid additives that provide the process improvements of the present invention include, but are not limited to, hydrous silicate (for example, PURTALC™ USP or LUZENAC NICRON™ 302), melamine, silica or fumed silica (for example, PPG FLOGARD™ FF, CABOT CAB-O-SIL™ TS-530), fly ash, metal-stearate salts, metal-carbonate salts (for example calcium carbonate), metal-sulfate salts (for example calcium sulfate or barium sulfate), zeolites or molecular sieves, clays, fluoropolymers, melamine, zinc oxide, and titanium diboride. Many of these additives, hydrous silicate in particular, have a further advantage because they do not change the color when added with the powder to a recipe for white foam. Hydrous silicate has an additional advantage in that, when small amounts of it are included in the foam recipe, hydrous silicate does not significantly affect the manufacture of new polyurethane foam nor does it significantly affect the physical properties of the foam. The favored hydrous silicate is talc.

It has been found that, not only the is the grinding of the polyurethane-containing material made much easier by the addition of the hydrous silicate, the conveying system performs in a smoother, steady state manner due to the lack of plating in ducts, fans, and cyclones. Moreover, the addition of hydrous silicate prevents the system screens from blinding and allows for the use of finer screens in the separation system.

There is no need to remove the hydrous silicate from the final product because it does not affect the desired properties of polyurethane foam made with recycled foam powder. In fact, several solid additives are known to be compatible with the manufacture of new polyurethane foam because they are used as fillers or combustion-modifying additives in foam, such as calcium carbonate, barium sulfate (barytes), and melamine. It has also been found that solid additives such as a hydrous silicate can also improve the flowability of polyurethane powders such as those obtained from comminution of polyurethane foam. Thus it can be advantageous to leave the solid additives in the final product, or even to add them to the final product. However, it is contemplated that one could physically or chemically separate the solid additive from the desired product in a subsequent step. It is further contemplated that the separated solid additives could then be recycled back into the grinding process.

As stated above, the favored hydrous silicate is talc, a term which, in a literal sense, refers to magnesium silicate Mg₃Si₄O₁₀(OH)₂ which is approximately 32% MgO, 65% SiO₂, and 5% H₂O. However, in a broader sense “talc” is used in the present disclosure to refer to minerals containing a major amount of the hydrous silicate Mg₃Si₄O₁₀(OH)₂ as well as the hydrous magnesium silicate itself.

Pure hydrous magnesium silicate has a crystalline structure that has a magnesium oxide/magnesium hydroxide sheet sandwiched between the two silica sheets. The repeating unit may be considered to be a divalent Mg₁₂O₁₆(OH)₈ interlayer sandwiched between the unit which interlayer is in turn linked to a second divalent Si₈O₁₂ sheet at the bottom. Each complete talc layer is made up of the magnesium/silica sheet layering and is electrically neutral. These complete, electrically neutral layers may be superimposed indefinitely, but the superimposed layers are held together by weak van der Waals forces. One of the characteristic properties of talc, its slippery property, is believed to result from the ability of the above discussed layers to slide over one another. The crystal form of talc can be foliated, lamellar, fibrous, or massive. Foliated and lamellar crystal forms are strongly hydrophobic.

Natural minerals typically referred to as talc can vary significantly in their content of hydrous magnesium silicate, Mg₃Si₄O₁₀(OH)₂. In natural minerals, the previously mentioned magnesium silicate can be associated with tremolite, a calcium magnesium silicate; the magnesium silicate anthophyllite and /or serpentine; and chlorite. Chlorite is a talc-like mineral in which varying proportions of aluminum are substituted for magnesium in the Mg₁₂O₁₆(OH)₈ interlayer. Impurities which are not aluminum and/or magnesium and/or calcium silicates may be present in natural mineral talc. For example, natural mineral talc may include carbonates, such as dolomite, and calcite; oxides, such as iron oxide, quartz and magnesium oxide, and elements such as carbon.

The present invention is further described in the following illustrative examples and drawing. The following examples and drawing are presented for illustrative purposes only and are in no way meant to limit the present invention.

### EXAMPLE 1A

Viscoelastic foam scrap was chopped into a flock comprising approximately 2-cm pieces using a rotary grinder. This flock was fed to a two-roll mill, which had counter-rotating slow and fast rolls with diameters of 30.5 cm, lengths of 45.7 cm, slow-roll and fast-roll speed ranges of 30 to 50 and 140 to 200 rpm respectively, with a gap of approximately 75 to 125 microns between the rolls through which the material to be ground must pass. All of the material leaving the mill was collected and conveyed to a centrifugal sifter of the type disclosed in U.S. patent application Ser. No. 09/748,307, in which was installed a screen with 200-micron openings. Also, the process was conducted with a 250-micron screen and with a 355-micron screen. Provision for conveying oversized material from the sifter oversize outlet back to the roll mill was made. Provision for collecting the fine polyurethane powder product from the sifter undersize outlet was made.

For each screen size, the screens blinded rapidly after startup and the process was required to shut down. That is, the screen openings were rapidly plugged by bits of polyurethane powder, and no useful production of fine powder could take place.

### EXAMPLE 1B

Viscoelastic foam scrap and high-resilience flexible polyurethane foam scrap (“HR”) were chopped into a flock comprising approximately 2-cm pieces. The ratio of viscoelastic to HR foam was varied from 100% viscoelastic to 20% viscoelastic. This flock was fed to a two-roll mill, which had counter-rotating slow and fast rolls with diameters of 61 cm, lengths of 122 cm, slow-roll and fast-roll speed ranges of 30 to 50 and 140 to 200 rpm respectively, with a gap of approximately 125 to 175 microns between the rolls through which the material to be ground must pass. All of the material leaving the mill was collected and conveyed to a centrifugal sifter of the type disclosed in U.S. patent application Ser. No. 09/748,307, in which was installed a screen with 200-micron openings. Also, the process was conducted with a 250-micron screen and with a 355-micron screen. Provision for conveying oversized material from the sifter oversize outlet back to the roll mill was made. Provision for collecting the fine polyurethane powder product from the sifter undersize outlet was made.

For each screen size, the screens blinded rapidly after startup and the process was required to shut down. That is, the screen openings were rapidly plugged by bits of polyurethane powder, and no useful production of fine powder could take place.

### EXAMPLE 1C

Conventional polyether polyurethane foam scrap was chopped into a flock comprising approximately 2-cm pieces using a rotary grinder. This flock was fed to a two-roll mill, which had counter-rotating slow and fast rolls with diameters of 30.5 cm, lengths of 45.7 cm, slow-roll and fast-roll speed ranges of 30 to 50 and 140 to 200 rpm respectively, with a gap of approximately 75 to 125 microns between the rolls through which the material to be ground must pass. All of the material leaving the mill was collected and conveyed pneumatically to a centrifugal sifter of the type disclosed in U.S. patent application Ser. No. 09/748,307, in which was installed a screen with 200-micron openings. Also, the process was conducted with a 250-micron screen and with a 355-micron screen. Provision for conveying oversized material from the sifter oversize outlet back to the roll mill was made. Provision for collecting the fine polyurethane powder product from the sifter undersize outlet was made.

For each screen size, a slow buildup of fine powder would plate the inside surfaces of the pneumatic conveying equipment such as the ducts, the fans, and the cyclones. As the plating thickened over a time span of a few hours, the production rate of fine powder decreased. Eventually, the process shut down suddenly because the plating in the cyclones had become so thick that the foam flocks and powder could no longer be conveyed. Also, the screens in the sifter were partially blinded throughout the production time. This caused a reduced rate of production, and also produced powder with a maximum particle size much smaller than the size of the screen openings.

### EXAMPLE 2A

In the present example, the process of Example 1B was repeated. However, the following feed materials and solid additive were substituted for the feed materials used in Example 1B:

a) fed to the process was a 20%/80% blend of visco/HR flock to which talc was added at a level of 0.5% by weight of the foam blend. The talc was NICRON™ 302 talc (99% 3MgO.4SiO₂.H₂O) from Luzenac America, Inc, which has a median particle size of 11.4 microns, with 100% passing a 75-micron screen, and a Hegman Fineness of 3.5.

b) additional talc was added to the sifter oversize outlet at a level of 1.5% by weight of the foam blend.

The above process was performed with a 200-micron screen in the sifter, the process ran without screen blinding or other process interruption. A quantity of 1,000 kg of finely ground polyurethane powder was produced.

Next, samples of the above powder product were passed through a 125-micron standard sieve and no measurable amount of powder was left on the sieve. The viscosity of slurry made with 20 parts of the powder product and 100 parts of Dow VORANOL™ 3010 polyether polyol was 2,970 mPa-s at 25° C. as measured by a Brookfield viscometer with spindle #4.

### EXAMPLE 2B

In the present example, the process of Example 1B was repeated. However, the following feed materials and solid additive were substituted for the feed materials used in Example 1B:

a) fed to the process was a 100% visco flock to which NICRON™ 302 talc was added at a level of 21.4% by weight of the foam.

b) additional talc was added to the sifter oversize outlet at a level of 8.4% by weight of the foam blend.

The above process was performed with a 200-micron screen in the sifter, the process ran without screen blinding or other process interruption. A quantity of 1,000 kg of finely ground polyurethane powder was produced.

Next, samples of the above powder product were passed through a 180-micron standard sieve and no measurable amount of powder was left on the sieve. In addition, samples of the powder product were also passed through a 125-micron standard sieve and 28% of the powder was left on the sieve. Finally, samples of the powder product were passed through a 75-micron standard sieve and 67% of the powder was left on the sieve. Assuming that 100% of the talc passed through each of the test sieves, the particle-size distribution of the ground polyurethane on a talc-free basis was: 4.6%, 60.1%, and 100% through 75, 125, and 180-micron sieves respectively. By mass balance, the composition of the powder product was 23% talc, 77% ground visco foam.

### EXAMPLE 2C

In the present example, the process of Example 1B was repeated. However, the following feed materials and solid additive were substituted for the feed materials used in Example 1B:

a) fed to the process was a 100% visco flock to which NICRON™ 302 talc was added at a level of 2.6% by weight of the foam.

b) additional talc was added to the sifter oversize outlet at a level of 1.5% by weight of the foam blend.

The above process was performed with a 200-micron screen in the sifter, the process ran without screen blinding or other process interruption. A quantity of 1,000 kg of finely ground polyurethane powder was produced.

Next, samples of the above powder product were passed through a 180-micron standard sieve and no measurable amount of powder was left on the sieve. In addition, samples of the powder product were passed through a 125-micron standard sieve and 35.9% of the powder was left on the sieve. Finally, samples of the powder product passed through a 75-micron standard sieve and 86.7% of the powder was left on the sieve. Assuming that 100% of the talc passed through each of the test sieves, the particle-size distribution of the ground polyurethane on a talc-free basis was: 9.2%, 62.5%, and 100% through 75, 125, and 180-micron sieves respectively. By mass balance, the composition of the powder product was 4% talc, 96% ground visco foam.

### EXAMPLE 3

In the present example, the process of Example 1C was repeated. However, the following feed materials and solid additive were substituted for the feed materials used in Example 1C:

The process of Example 1C was repeated except that carbon black was added to the sifter oversize outlet at a rate equal to 1% by weight of the rate that foam flock was fed to the mill.

The process ran without interruption. There was no observable plating of powder on the inside surfaces of either the ductwork or the cyclones. Similarly, the inside surfaces of the sifter were clean of powder buildup. The screen in the sifter was very clean and appeared to be completely free of any visual evidence of blinding. In comparison with the results of Example 1C, the maximum particle size of the powder product from the present example was nearer to the size of the screen openings in the sifter.

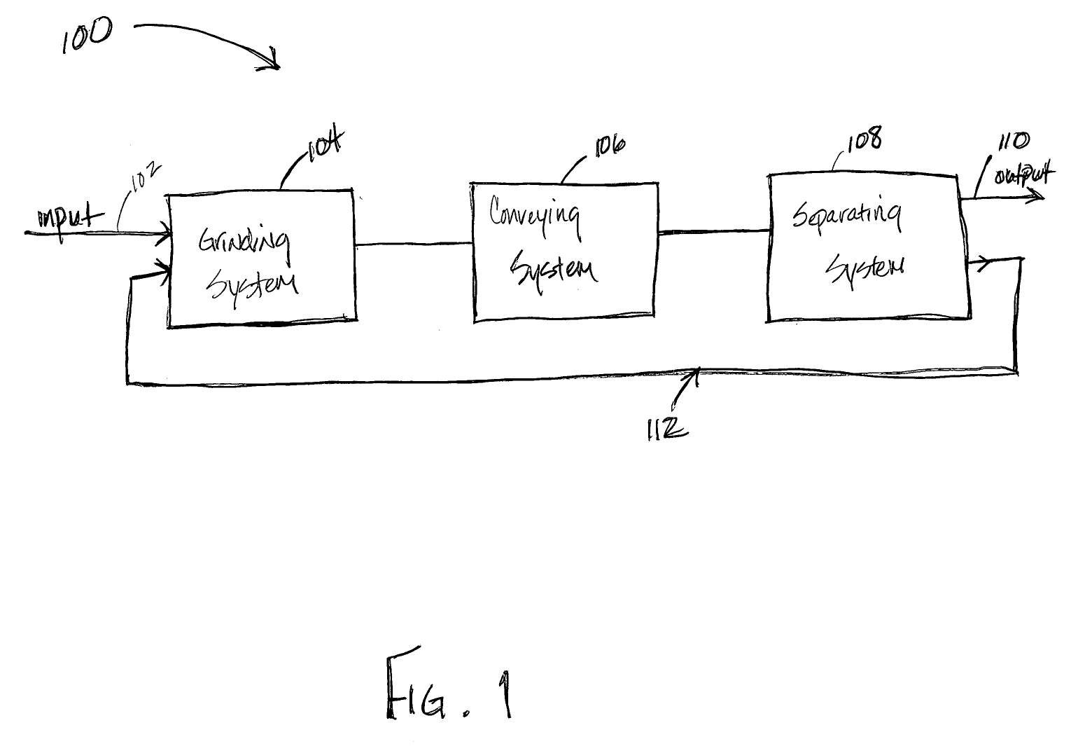

FIG. 1 is a simplified schematic diagram illustrating an example of a comminution/pulverization process of the present invention and as in the above examples. As shown in the comminuting/pulverization process 100 of FIG. 1, input 102 provides an input site for polyurethane-containing materials, for example polyurethane foam, to the grinding system 104. A typical grinding system 104 uses a two-roll mill, with counter-rotating slow and fast rolls. As one of ordinary skill in the art would readily recognize, other types of grinding systems may be used with the present invention. The polyurethane-containing material is ground to a particle size distribution that contains some fine powder product and some coarse material in grinding system 104. The polyurethane-containing material is then transported from grinding system 104 to conveying system 106. Conveying system 106 conveys the particles of polyurethane-containing material to the separating system 108. Separating system 108 may be comprised of one or more screens, which may consist of varying degrees of fineness. Separating systems without screens, such as air classifiers, may alternatively be used for separating system 108. Feedback loop 112 is coupled to one output of separating system 108 to provide an avenue for larger particles to be fed back into grinding system 104. polyurethane-containing material is output though output 110. The method of adding solid additives to the polyurethane-containing material may be used at output 110 to improve the flowability of the powder as the powder is moved out of comminution/pulverization process 100 is used in other processes. An example of a comminution/pulverization process 100 suitable for use with the present invention is set forth in detail in U.S. patent application Ser. No. 09/748,307, entitled “POLYMERIC FOAM POWDER PROCESSING TECHNIQUES, FOAM POWDERS PRODUCTS, AND FOAMS PRODUCED CONTAINING THOSE FOAM POWDERS,” hereby incorporated herein by reference.

As demonstrated in Examples 1A and 1B, separating system 108, specifically the screens (not shown) used in separating system 108, was rendered inoperative due the plugging of the screen openings with powder. Thus, comminution/pulverization process 100 required shut down due to plating and blockage of grinding system 104, conveying system 106 and separating system 108. As shown in Example 1C, using conventional polyurethane foam, the screens in separating system 108, though not rendered inoperative immediately, were partially blinded throughout production time. However, the plating in conveying system 106, specifically the ducts, fans, and the cyclones (not shown), became so thick that the foam flocks could not be conveyed through the system. Thus, comminution/pulverization process 100 was rendered inoperative due to blockages caused by foam powder.

Ideally, comminution/pulverization process 100 would have a steady state rate of production, i.e. for every pound of flock introduced into the system, a pound of powder and/or particles would be produced, without any unnecessary blockages of comminution/pulverization process 100. However, as shown in Examples 1A through 1C comminution/pulverization process 100 was rendered inoperative in each case due to the plating and eventual blockage of various systems in comminution/pulverization process 100.

As shown in examples 2A through 2C, the addition of talc to comminution/pulverization process 100 increased the production rate to steady state. Example 2A illustrates that by adding 0.5% by weight of talc with a 20/80 blend of viscoelastic/HR foam, a 100% recovery rate was achieved by comminution/pulverization process 100 using a 200 micron screen in the sifter. The powder product was then tested further to determine the particle size of the powder product. A quantity of 1,000 kg of powder product was passed through a 125 micron standard sieve and no measurable amount of powder was left on the sieve.

Example 2B illustrates that by adding 21.4% with 100% viscoelastic foam and adding an additional 8% to the sifter outlet, a 100% recovery rate was achieved by comminution/pulverization process 100 using a 200 micron screen in the sifter. A quantity of 1,000 kg of powder product was then passed through a 180-micron standard sieve to determine particle size and no measurable amount of powder was left on the sieve. Comparably, using a 125 micron sieve to determine particle size, a 60.1% recovery was achieved and using a 75 micron screen to determine particle size, a 4.6% recovery rate was achieved by comminution/pulverization process 100.

Finally, Example 2C illustrates that by adding 2.6% with 100% viscoelastic foam and adding an additional 1.5% to the sifter outlet, a 100% recovery rate was achieved by comminution/pulverization process 100 using a 200 micron screen in the sifter. A quantity of 1,000 kg of powder product was then passed through a 180-micron standard sieve to determine particle size and no measurable amount of powder was left on the sieve. Comparably, using a 125 micron sieve to determine particle size, a 62.5% recovery was achieved and using a 75 micron screen to determine particle size, a 9.2% recovery rate was achieved by comminution/pulverization process 100.

In Example 3, 1% by weight of carbon black was added to 100% polyether polyurethane foam scrap at the sifter outlet. A 100% recovery rate was achieved by comminuting/pulverization process 100.

While the above description pertains to polyurethane-containing materials, it should be well understood that the present invention may also be applied to some non-polyurethane containing materials. For example, various types of carpets, in the sense that these carpets (that contain little or no polyurethane containing materials) can be ground into fine particles and that the process can be improved by the addition of solid additives according to the invention.

It should be understood that various alternatives to the embodiments of the disclosed method described herein may be employed in practicing the disclosed method. It is intended that the following claims define the scope of the disclosed method and that methods within the scope of these claims and their equivalents be covered thereby.

What is claimed is:

1. A method of comminuting/pulverizing polyurethane-containing materials to produce fine particles comprising:
chopping the polyurethane-containing materials, thereby producing a polyurethane-containing flock;
processing further said polyurethane-containing flock through at least one input of a comminuting/pulverizing process having an output, wherein said comminuting/pulverizing process has at least two steps; and
adding a solid additive at any time during the comminuting/pulverizing process.

2. The method according to claim 1 wherein said polyurethane-containing materials are polyurethane foam.

3. The method according to claim 1 wherein said solid additive is added at said at least one input of said comminuting/pulverizing process with said polyurethane-containing materials.

4. The method according to claim 1 wherein said solid additive is added at said output of said comminuting/pulverizing process with said polyurethane-containing particles.

5. The method according to claim 1 wherein said solid additive is added during a recirculation loop that returns oversized polyurethane-containing materials to a mill for continued comminution.

6. The method according to claim 1 wherein said solid additive is approximately 0.5 microns to 200 microns in size.

7. The method according to claim 1 wherein said solid additive is approximately 0.2 mm to 5 mm in size.

8. The method according to claim 1 wherein said solid additive is electrically conductive.

9. The method according to claim 10 wherein said electrically conductive solid additive is chosen from the group consisting of carbon black, graphite, flaked metals, powdered metals, conductive metal oxides and electrically insulating materials coated with tin oxide.

10. The method according to claim 1 wherein said solid additive is electrically insulating.

11. The method according to claim 10 wherein said electrically insulating solid additive is chosen from the group consisting of hydrous silicate, silica and fumed silica, fly ash, metal-stearate salt, metal-carbonate salt, metal-sulfate salt, zeolite, melamine, molecular sieve, clay, fluoropolymer, zinc oxide, and titanium diboride.

12. The method according to claim 1 wherein said solid additive is added in an amount of approximately between 500 ppm and 40% by weight.

13. The method according to claim 1 wherein said solid additive is added in an amount of approximately between 0.1 and 30% by weight.

14. The method according to claim 1 wherein said solid additive is added in an amount of approximately between 0.2 and 10% by weight.

15. The method according to claim 1 wherein said comminuting/pulverizing process has at least two steps further comprising:
a grinding step having two inputs and an output, wherein a first input is an feed input and a second input is a feedback input; and
a separation step having an input and two outputs, wherein an input is coupled to an output of said grinding step, and a first output is a product output, and a second output is a feedback output coupled to said feedback input of said grinding step.

16. The method according to claim 15 wherein said comminuting/pulverizing process further comprises a conveying system step between said grinding step and said separating step.

17. The method according to claim 15 wherein said separating step further comprises a sifter having at least one screen.

18. The method according to claim 17 wherein adding said solid additive prevents blinding of said at least one screen in said sifter.

19. The method according to claim 15 wherein adding said solid additive improves grinding in said grinding step.

20. The method according to claim 15 wherein adding said solid additive prevents plating in said separation step.

21. The method according to claim 16 wherein adding said solid additive prevents plating in said conveying system step between said grinding step and said separating step.

22. The method according to claim 4 wherein adding said solid additive at said output of said comminuting/pulverizing process with said polyurethane-containing particles improves the flowability of said polyurethane-containing particles.

23. The method of comminuting/pulverizing polyurethane-containing materials to produce fine particles according to claim 13 wherein said fine particles are used to produce polyurethane-containing foam having approximately 0.01 to 10% by weight of said electrically insulating solid additive.

24. A method of comminuting/pulverizing polyurethane-containing materials to produce fine particles comprising:
chopping the polyurethane-containing materials, thereby producing a polyurethane-containing flock;
processing further said polyurethane-containing flock through at least one input of a comminuting/pulverizing process having an output, wherein said comminuting/pulverizing process has at least two steps; and
adding hydrous silicate at any time during the comminuting/pulverizing process.

25. The method according to claim 24 wherein said polyurethane-containing materials are polyurethane foam.

26. The method according to claim 24 wherein said hydrous silicate is added at said at least one input of said comminuting/pulverizing process with said polyurethane-containing materials.

27. The method according to claim 24 wherein said hydrous silicate is added at said output of said comminuting/pulverizing process with said polyurethane-containing particles.

28. The method according to claim 24 wherein said hydrous silicate is added during a recirculation loop that returns oversized polyurethane-containing materials to a mill for continued comminution.

29. The method according to claim 24 wherein said hydrous silicate is approximately 0.5 microns to 200 microns in size.

30. The method according to claim 24 wherein said hydrous silicate is approximately 0.2 mm to 5 mm in size.

31. The method according to claim 24 wherein said hydrous silicate is added in an amount of approximately between 500 ppm and 40% by weight.

32. The method according to claim 24 wherein said hydrous silicate is added in an amount of approximately between 0.1 and 30% by weight.

33. The method according to claim 24 wherein said hydrous silicate is added in an amount of approximately between 0.2 and 10% by weight.

34. The method according to claim 24 wherein said comminuting/pulverizing process has at least two steps further comprising:
a grinding step having two inputs and an output, wherein a first input is an feed input and a second input is a feedback input; and
a separation step having an input and two outputs, wherein an input is coupled to an output of said grinding step, and a first output is a product output, and a second output is a feedback output coupled to said feedback input of said grinding step.

35. The method according to claim 34 herein said comminuting/pulverizing process further comprises a conveying system step between said grinding step and said separating step.

36. The method according to claim 34 herein said separating step further comprises a sifter having at least one screen.

37. The method according to claim 36 wherein adding said solid additive prevents blinding of said at least one screen in said sifter.

38. The method according to claim 37 herein adding said hydrous silicate prevents plating in said grinding step.

39. The method according to claim 34 wherein adding said hydrous silicate prevents plating in said separation step.

40. The method according to claim 35 wherein adding said hydrous silicate prevents plating in said conveying system step between said grinding step and said separating step.

41. The method according to claim 27 wherein adding said solid additive at said output of said comminuting/pulverizing process with said polyurethane-containing particles improves the flowability of said polyurethane-containing particles.

42. The method of comminuting/pulverizing polyurethane-containing materials to produce fine particles according to claim 24 wherein said fine particles are used to produce polyurethane-containing foam having approximately 0.01 to 10% by weight of said hydrous silicate.
